(19) United States
(12) Patent Application Publication
(10) Pub. No.: US 2013/0054469 A1
(43) Pub. Date: Feb. 28, 2013

(54) COMPUTER IMPLEMENTED MULTI-LEVEL TRANSACTION AUTHORIZATION BANKING SUPPORT SYSTEM AND METHOD THEREOF

(71) Applicants: Mandar Agashe, Maharashtra (IN); Sumeet Phadnis, Maharashtra (IN)

(72) Inventors: Mandar Agashe, Maharashtra (IN); Sumeet Phadnis, Maharashtra (IN)

(73) Assignee: SARVATRA TECHNOLOGIES PVT LTD., Maharashtra (IN)

(21) Appl. No.: 13/405,458

(22) Filed: Feb. 27, 2012

(30) Foreign Application Priority Data
Aug. 26, 2011 (IN) 2401MUM2011

(51) Int. Cl. G06Q 20/40

(52) U.S. Cl. 705/67

(57) ABSTRACT

A computer implemented system and method for multi-level transaction authorization in a banking support unit. The system includes a data center with a cluster further including: (i) a host for processing transactions, (ii) a security module authenticating and generating a customer personal identification number (PIN), authentication means for authenticating a point-of-sales (POS) terminal, and encryption means for encrypting all information and POS transactions. The system further includes a maker-checker unit further comprising: a token number generator for conducting sensitive transactions on said POS by unique tokens validated for adaptability with said cluster; and an authorization cards array to configured to effectuate multi-level authorization of primary and subsidiary transactions while selectively linking said primary and subsidiary transactions to said token number generator.

### CROSS-REFERENCE TO RELATED APPLICATIONS

This application claims priority from Indian Patent Application No. 2401/MUM/2011 filed 26 Aug. 2011, and is an improvement of the invention described in Indian Patent Application No. 994/MUM/2003 filed on 22 Sep. 2003, now Indian Patent No. 242692 published 10 Sep. 2010, the entire contents of each of which are specifically incorporated herein by reference.

### FIELD OF DISCLOSURE

The present disclosure relates to the field of conducting banking transactions. Particularly, the present disclosure relates to the field of multi-level transaction authorization in a banking support system.

### DEFINITION OF TERMS USED IN THIS SPECIFICATION

The term ‘POS’ in this specification relates to a point-of-sale terminal that is an electronically controlled unit provided at branches and outlets of an integrated banking network.

The term ‘PIN’ in this specification relates to a personal identification number that allows exclusive access to a user holding a debit or credit card linked to a bank account.

The term ‘AWM system’ in this specification relates to an anywhere money system that allows a bank account holder to withdraw and deposit money through an array of POS terminals.

The term ‘EFT’ in this specification relates to an Electronic Financial Transaction switch that routes transactions from various delivery channels to a bank host based on a Bank Identification Number (BIN).

These definitions are in addition to those expressed in the art.

### BACKGROUND AND PRIOR ART

Typically, banking transactions are conducted in two ways. Firstly, a customer walks into his bank and manually performs transactions with a bank officer or a cashier. Secondly, ATMs are provided where a customer can perform banking transactions at locations remote from his actual branch. However, both methods have their limitations. Although ATMs are becoming increasingly popular, they are very expensive for the bank and small banks cannot utilize the ATM systems and services.

Conventional POS terminals available at merchant sites do not have a multi-level authorization system but only a signature based authentication mechanism for approving transactions done at merchant sites. However, the POS terminals do not require a customer to enter a PIN while conducting a transaction and anybody can swipe a debit or credit card and put a signature on transaction slip. Thus, transactions done on POS terminals are not secure as they should be for a banking network. Further, a way to withdraw and deposit cash at the ATMs is by means of a single level authentication that is the customer only needs to a have a card and a personal identification number (PIN). However, many people have PIN written on slip or paper in their wallet or in electronic diaries of cell phones that is risky because if a customer looses his wallet and cell phone, it is likely that some miscreant can withdraw money from the ATM while posing as a bank account holder.

Further, conventional banking units do not have a branch specific authorization cards enablement and disablement features, that can cause fraudulent transactions as typical cards and personnel authorization requests have to be routed through centralized authorization servers. A delay in request approval by the centralized authorization servers can cause PIN and password theft, thereby encouraging miscreants to conduct cash and credit transactions in the name of a beneficiary. Moreover, conventional ATM units have a unified transactional limit on an annual or a quarterly basis and there is no area and zone wise demarcation of the transactional limits per ATMs. For ATMs located in rural, semi-urban and underdeveloped zones there is an imminent risk of miscreants to a beneficiary who withdraws high amounts in sensitive zones.

Typical banking units have a single level authorization requirement for conducting cash, credit, and debit transactions. Further, an immediate authority to curb fraudulent transactions is not empowered in conventional banking units. Thus, detection of a fraudulent banking transaction is routed through a central banking server that can cause loss to the bank and can add to panic of the customer. Therefore there is felt a need for a system which can:
configure interactive units and information processors with a core banking network via communication medium like a dial-up module over a wired communication line and a wireless communication line;
configure multi-card and multi-personnel authorization for transactions done through POS terminals;
link sensitive transactions creation and authorization with a unique identification number;
reject transactions originating from POS terminals unless approved by authorized cards and authorized personnel;
schedule an execution of a transaction while allowing a beneficiary to generate a transaction cancellation request;
establish transaction limits varying across a plurality of POS terminals; and
configure a unique supervisory restriction on multi-card and multi-personnel authorization.

### OBJECTS

Some of the non-limiting objects of the present disclosure, which at least one embodiment herein satisfy are as follows:

It is an object of the present disclosure to configure a multi-level transaction authorization banking support system.

It is another object of the present disclosure to configure a POS system for interaction and information processing with a core banking network.

It is still another object of the present disclosure to configure a multi-level authentication for effectuating sensitive transactions through the POS terminals.

A related object of the present disclosure is to enable transition of subsidiary functions of a core banking system to POS terminals.

It is further an object of the disclosure to link sensitive transaction creation and authorization with a unique identification number.

It is yet another object of the disclosure to block and reject semi-approved transactions,

Indian Patent No. 242692 (994/MUM/2003), provides an apparatus and method for conducting banking transactions including depositing and withdrawal of cash by an account holder in a branch of a bank from any of other bank branches or authorized outlets of said branches having a unique bank identification number. The apparatus includes a data center with a cluster further including a host for processing transactions, a security module adapted to authenticate and generate a customer PIN, encryption means for encrypting all information and POS transactions, and authentication means for authenticating a POS terminal. The apparatus further includes an interface for the electronic financial switch for reading a request from the switch, deciphering said request, forwarding requests to the host for processing and sending processed information to the switch. The apparatus also includes data storage means for storing data and an operations center for maintaining record of all transactions. The apparatus includes POS terminals provided at all branches and other authorized outlets, said POS terminals having serial interface for external devices such as printer, PIN Pad, and the like. The apparatus further includes account data storage means for storing remotely operable client account information and record at all said branches and other authorized outlets.

The apparatus further includes a network interface linking the data center to the operations center, the POS terminals to the data center and said account data storage means to the data center via a network such as PSTN Dialup, GSM, Ethernet, and the like for accessing the accounts of any account holder in any branch of a bank. The apparatus includes a card on which is recordable account information of an account holder, which card is readable by aid of said POS terminals. Further, a network access controller is included in the apparatus that comprises a bank of modems for dialup connectivity with the POS terminals and adapted to accept information for the POS terminals and forward to the electronic financial switch that is adapted to send and receive information from the POS terminals via the linked network and send and receive information from said account data storage means in the branches, and the switch is further adapted to selectively route transactions to and from bank branches based on bank identification number and adapted to fetch and store information of all such transactions in the operations center, and the interface in the cluster including an ISO 08583 interface is adapted to read requests from the electronic financial switch in the IS08583 format, decipher it and forward it to the host for processing.

### SUMMARY

In accordance with the present disclosure, there is provided a system and a method for multi-level transaction authorization in a banking support unit. The system includes a data center with a cluster further including: (i) a host for processing transactions, (ii) a security module authenticating and generating a customer personal identification number (PIN), authentication means for authenticating a point-of-sales (POS) terminal, and encryption means for encrypting all information and POS transactions, and (iii) an interface for an electronic financial switch for reading a request from said switch, deciphering said request, forwarding requests to said host for processing and sending processed information to said switch and data storage means for data storage; and a maker-checker unit further comprising: a token number generator for conducting sensitive transactions on said POS by unique tokens validated for adaptability with said cluster; and an authorization cards array to configured to effectuate multi-level authorization of primary and subsidiary transactions while selectively linking said primary and subsidiary transactions to said token number generator.

Typically, the POS terminal further includes a serial interface for external devices selected from a group consisting of a PIN pad and a transaction slip printer.

Typically, the authorization cards array includes transaction authorization cards to approve or decline transactions; branch master card enabling a banking support branch head to authorize cards pertaining to said banking support branch; account operation cards enabling a core banking account holder to conduct various banking transactions through said banking support branch; collection cards enabling credit of funds to a core banking account; and POS maintenance cards enabling modification parameter setting on said POS terminal except for financial transactions. The banking support branch is a branch approved by a core banking network in line with central banking guidelines and regulations, said banking support branch further comprising at least one said POS terminal.

Typically, the POS terminal is further adapted to schedule an execution of a transaction on a future date, and wherein said POS terminal displays a graphical list enabling a banker to manually select said future date.

In accordance with the present disclosure, there is provided a method for multi-level transaction authorization, said method including: linking a plurality of POS terminals to a data center with a cluster and linking an account data storage means to said data center; creating banking transaction by generating unique token numbers; exclusively authorizing said banking transaction via said unique token numbers; and making primary and subsidiary banking transactions restrictive through authorization cards and selectively restrictive through said unique token numbers.

Typically, the unique token numbers are enabled for conducting sensitive banking transactions on said POS, said unique token numbers validated for compatibility with said cluster.

Typically, the step of linking a plurality of POS terminals comprises a step of configuring an electronic financial transaction switch in said data center for, sending and receiving information via said POS terminal, and sending and receiving information via said account data storage means, pertaining to core banking branches.

Specifically, the step of configuring said electronic financial switch further comprises steps of: adapting said electronic financial switch to selectively route transactions to and from said core banking hosts based on a bank identification number; and further adapting said electronic financial switch to fetch and store information of all such transactions in an operations center.

Typically, the step of making primary and subsidiary transactions restrictive includes the steps of: enabling an authorized person to authorize all cards pertaining to a banking branch; securely endorsing said unique token number by swiping authorizer cards while conductive sensitive banking transactions; enabling credit of funds to an account and debit of funds from an account; enabling modification parameter setting on said POS terminal excluding financial transactions; transferring funds from a first banking account to a second banking account after validating manual communication of said unique token number from transferor to transferee, said transferring funds selectively scheduled for credit and debit operations; imposing POS terminal specific transaction limits; linking core banking transactional limits to said POS terminal specific transaction limits; and issuing cheque books and clearing cheques responsive to said unique token number.

Specifically, the step of transferring funds comprises a step of enabling a banker exercise an option selected from carrying out a transaction immediately, or on a future date, and wherein an amount pertaining to said transaction is blocked in transferor's account and transferee accepts said amount on receiving said unique token number.

Typically, the method further includes a step of activating a new banking card using an authorization card and by forcing a change of the standard PIN of the new card in a banking support branch.

### BRIEF DESCRIPTION OF THE DRAWINGS

Other aspects of the disclosure will become apparent by consideration of the accompanying drawings and their descriptions stated below, which is merely illustrative of a preferred embodiment of the disclosure and does not limit in any way the nature and scope of the disclosure. In the drawings:

FIG. 1 is a schematic of a system for configuring multi-level authorization in a banking support unit; and

FIG. 2 is a flowchart depicting a method of multi-level authorization in a banking support unit.

### DETAILED DESCRIPTION

The disclosure for multi-level transaction authorization in a banking support unit will now be described with reference to the accompanying drawing which does not limit the scope and ambit of the disclosure. The description provided is purely by way of example and illustration.

Conventional POS terminals available at merchant sites do not have a multi-level authorization system but only a signature based authentication mechanism for approving transactions done at merchant sites. However, the POS terminals do not require a customer to enter a PIN while conducting a transaction and anybody can swipe a debit or credit card and put a signature on transaction slip. Thus, transactions done on POS terminals are not secure as they should be for a banking network. Further, way to withdraw and deposit cash at the ATMs is by means of a single level authentication that is the customer only needs to a have a card and a personal identification number (PIN). However, many people have PIN written on slip or paper in their wallet or in electronic diaries of cell phones, which is risky because if a customer looses his wallet and cell phone, it is likely that some miscreant can withdraw money from the ATM.

To overcome these shortcomings, the present disclosure provides a system and method for multi-level transaction authorization in a banking support system.

In accordance with one aspect of the present disclosure, a system for multi-level transaction authorization in a banking support unit is disclosed, wherein said transaction including depositing and withdrawal of cash, securely and remotely through the anywhere banking system. The system includes anywhere money (AWM) features and is capable of conducting all primary and subsidiary banking transactions including issue and delivery of chequebooks.

Again, according to the first aspect, the system can include an apparatus for conducting banking transactions including depositing and withdrawal of cash by an account holder in a branch of a bank from any of the other bank branches or other authorized outlets each of said branches having a unique bank identification number; said apparatus including: (a) data center having a cluster as herein defined and data storage means for storage of data; (b) an operations center for maintaining operations; (c) point of sale (POS) terminals provided at all the said branches and other authorized outlets; (d) account data storage means for storing remotely operable client account information and record at all the said branches and other authorized outlets; (e) a token number generator for conducting sensitive transactions through said POS; and (f) an authorization cards array to authorize primary and subsidiary transactions while selectively linking said transactions to said token number generator.

The system according to the first aspect, can further include (a) Network Interfaces linking: the data center to the operation center, the point of sale (POS) terminals to the data center and the said account data storage means to the data center via a network such as public switched telephone network (PSTN) Dialup, Ethernet, mobile network and the like for accessing the accounts of any account holder in any branch of a bank; (b) a card as herein defined contains recordable account information of an account holder, said card is readable by the aid of POS terminals; (c) an electronic financial transaction (EFT) switch provided in the data center adapted to send and receive information from the POS terminals via the linked network and send and receive information from said account data storage means in the branches and further adapted to selectively route transactions to and from bank branches based on the bank identification number and adapted to fetch and store information of all such transactions in the operations center.

In accordance with a preferred embodiment of the disclosure, the electronic financial switch is adapted to interface with other electronic financial switches of other institutions for inter institution transactions. The POS terminals have a serial interface for external devices such as a printer, PIN Pad and the like. In addition, the POS terminals can have an Ethernet interface for connecting the POS to a local area network and an internal or external GSM or CDMA modem for connecting the POS terminals to EFT switch network. In accordance with a preferred embodiment of this disclosure, the data center includes a network access controller comprising a bank of modems for dialup connectivity with the POS terminals and adapted to accept information from the POS terminals and forward to the electronic financial switch. In accordance with a preferred embodiment of this disclosure, the data center includes a cluster having (i) a host which is a processing means for processing transactions,(ii) a security module adapted to authenticate and generate a customer PIN, encryption means for encrypting all information and POS transactions, and authentication means for authenticating a POS terminal and (iii) a service interface for the electronic financial switch for reading a request from the switch, deciphering said request, forwarding requests to the host for processing and sending processed information to the switch. In accordance with a preferred embodiment of this disclosure, the electronic financial switch is adapted to maintain a log of every transaction received along a delivery channel from a POS terminal and store such a log data in the cluster. In accordance with this disclosure, the cluster includes an interface between the said switch and the said host security module.

Further, on receipt of an account opening request, a card account will be created in the system in a sub-ledger under the respective customer account. A PIN will be generated for the account and will be sent to the subscriber in a standard secure PIN mailer, Transactions like Cash withdrawal, Deposit, Transfer can be carried out using the PIN. All the accounting will be done with the customer's main bank account in addition to the customer account at POS terminal. For cash withdrawal (at a bank branch) and sale (at a merchant location), customer account will be debited. For cash deposit at a bank branch, customer account will be credited.

In an embodiment, the system and method of present disclosure include an array of multi-level authorization modules including the following: The POS terminals used need a “Sign-on” to the system regularly (at a configurable time interval) and optionally at every power-on. The sign-on generates a new working key for encryption of sensitive data transmitted from the POS terminal. Authorizer cards are issued to bank officials (for in branch POS terminals) and merchants (for merchant location POS terminals). The accounting entries related to the POS are done to an account that is identified by the authorizer card. Further, as an additional (and optional) security measure, the Bank can opt for verification for all cash transactions on the system. In such a case, cash deposit, withdrawal and funds transfer transactions will require verification by a bank official. A customer can initiate a transaction from the POS terminal and would get a unique token number generated by the system. Further, by using POS terminal where transaction is carried out or a different terminal, a bank official would authorize the transaction using the token number after verifying customer credentials. A customer's account is affected only after the transaction has been verified. Further, an authorized officer has the option to reject the transaction.

In another embodiment, transfer of funds can be verified. The transaction for transfer of funds from one card to another also can occur in two steps. In a first step, the transferor (person whose account is to be debited) initiates the transaction by swiping his/her card, entering the PIN, amount to be transferred and card number to transfer funds to. Thus, transaction done and transaction complete status can be generated on the host and the amount to be transferred can be blocked on the transferor's account. The amount will not be immediately credited to the transferee's account and the POS will print a token number. Further, the transferor manually communicates this token number to the transferee, whereby the transferee can initiate a new transaction on the POS called “Accept Transfer” by swiping his/her card and entering the token number. Further, the amount can get credited to account of transferee, whereby the transferee will have a choice to reject the transaction. In such a case, the original transaction will be reversed and the amount will get credited back to the transferor's account.

In another embodiment, a transfer of funds can be scheduled, wherein at the time of entering a transfer instruction, the transferor can schedule execution for a future date. Herein, the POS will show a menu to the user wherein the user has a choice whether to carry out the transfer immediately or on a future date by entering number of days to hold the transaction. Further, the system is configured to generate a token number as described in the specification and block the amount in transferor's account. The transferee, upon getting the transaction token number from the transferor, can accept the transaction on or after the scheduled transaction date. The transferee can cancel the transaction any time, even before the scheduled date.

In another embodiment, POS daily/weekly/monthly transaction limits can be configured, wherein the system is capable of imposing transaction limits (by value) on a POS terminal basis. The POS terminal is identified by the authorizer card that is used to verify a transaction. There can be a per-transaction limit as well as per day limit on the authorizer card that is associated with a POS terminal.

In an embodiment, the systems and methods of the present disclosure disclose a plurality of banking transaction modules including a mini-statement of account generation. Further, the system mails periodic (monthly/quarterly/annual) statements of account to customers. In addition, customers can request, from a POS terminal, printing of statement of account, showing last 10 transactions, for example, wherein each of these transactions may attract a different charge to the account. Further, the an embodiment discloses new banking card activation, wherein new cards are issued with a standard PIN, and no separate PIN mailer will be sent. Further, the new cards will be disabled for use initially and will be delivered to the bank's branch where the customer belongs. An officer at the branch will hand over the card after verifying the identity of the card holder and also verify the photograph if printed on the card. The new card will be enabled in the system only after a bank officer activates it and forces a PIN change. The system will not allow transactions from a card if its PIN is set to the standard PIN. The only transaction that is allowed in such a state is a PIN Change transaction via any of the ATM or POS terminals of the bank.

In an embodiment of the disclosure, the system is configured for anywhere banking using simple devices like EFT Point of Sale (POS) terminals that interact with a core banking system using basic communication medium like dial-up over wired or wireless telephone networks. The system can include Transaction Authorization cards with photograph, issued to employees of the bank who will be allowed to authorize various transactions in the system. Such authorization cards can also be used to initiate certain transactions where customer's card is not present, for example in the case of a cheque being presented. Further, the system can include branch key cards that are in ownership of the person in charge (typically the branch manager) of the branch of the bank where the POS terminal is installed. The key card is linked to a reconciliation account for that branch. Further, Account Operation cards are cards with photograph of the account holder and can be used to carry out various banking transactions on the account.

In an embodiment, the systems and method of the present disclosure include collection cards that are non-photo cards only allowing funds to be credited to the account. Even balance inquiry is not possible with these cards. Further, POS Maintenance Cards include viewing/modification of certain parameter setting on the POS terminal, wherein financial transactions are not possible with these cards. Such cards are typically given to service engineers who maintain the POS terminals.

Further, the systems and methods of present disclosure can include following features. Intelligent Menu on POS Terminals that is driven by a software on POS terminals to recognize the type of the card swiped and present a menu appropriate to that type of card, for example: Branch Key Cards to register POS; Attach Authorization Card; Detach Authorization Card; Activate Card; Change PIN; Daily Transaction Report; Branch Hand-off, Reset PIN and the like. The system also includes Transaction Authorization Cards Menu further including: Activate Card; Withdrawal Authorization; Deposit Authorization; Transfer Authorization; Cheque Deposit Authorization; Cheque book Issue; Inward Cheque Entry; Inward Cheque Authorization; Branch to Card Funds Transfer; Chequebook maintenance; Change PIN and the like.

The system also includes a plurality of Regular Cards including the following features: Balance Inquiry; Cash Withdrawal; Cash Deposit; Card-to-card Funds Transfer; Card-to-branch Funds Transfer; Mini Statement; Cheque Deposit; and Change PIN. The system further includes a POS Maintenance Cards menu that includes: communication setup; switch sign-on; and batch maintenance. The system also includes a POS Registration feature, wherein every PUS terminal needs to be registered in the system by swiping a Branch Key card. Further, until and unless POS is registered to a branch, transactions from the POS terminals will not be accepted by the system.

In an embodiment, the system includes attachment/detachment of Authorization Cards to a Branch feature, wherein by using the Branch Key cards, one or more Transaction Authorization Cards can be attached to the branch. Further, a given transaction authorization card can be attached to only one branch at a time. If a bank employee gets transferred to another branch, then his/her authorization card must be first detached from the original branch and then attached to the branch he/she joins. The Transaction Authorization Cards must be attached to a branch before they can be used to authorize or initiate any transactions. Further, transaction authorization cards can be used only on POS terminals that are registered to the same branch to which the authorization card is attached.

In another embodiment, the system can include a Transaction authorization feature, wherein all financial transactions like cash withdrawal, deposit, or funds transfer are carried out in a two step process. In the first step, the card on which the transaction is to be done is used along with its PIN to generate a transaction token. In the second step, a transaction authorization card is used along with its PIN to complete the transaction. As an additional check, the bank officer enters the transaction amount that gets verified by the system. Further, entry and authorization of transactions can happen on one and the same POS terminals, or on different terminals, but as a security measure the system may force completion of transaction in the same branch where it was originated. Moreover, each card issued in the system belongs to a home branch where the physical application form and related documents are maintained. The bank may decide to have a different transaction fee structure for transactions carried out at the home branch, at other branches, at merchant establishments and at branches of other financial institutions.

In another embodiment, the system can include clearing (cheques) Transactions modules, wherein the system also allows cheque transactions in following ways: Depositing cheques in an account, wherein any branch of the issuing bank can accept cheques to be deposited in a card account. The cheque will be sent for clearing along with other cheques and will be credited to a clearing suspense account. At this time, a cheque deposit entry will be made in the system from the POS terminal and a token will be printed on the receipt. When the cheque is cleared, a transaction authorization card will be used to authorize the cheque deposit entry. At this time, card account will be credited and branch account will be debited in the system along with fee entries if any.

The system can further include a Cheque book Issue module, wherein a card holder can go to his/her home branch and request for a cheque book for card holder's account. The branch will issue cheque book and register in the system using a transaction on the POS terminal, with a transaction authorization card. The cheque serial numbers issued to the customer will be registered in the system. Further, the system includes an inward clearing module, wherein cheques issued by the customers will be presented to the home branch for clearing. Further, home branch has the application form and specimen signatures of the account holder. Once the physical instrument and the signature are verified, branch person will enter the inward clearing transaction in the system from a POS terminal, by giving the cheque number and amount. The system will verify the cheque number, and return the name, card number and account number associated with the cheque number and the same will be printed on the transaction slip. Another bank official will authorize inward cheque using his/her transaction authorization card. At this time the balance of the card holder account will be reduced by cheque amount and fees, if any.

In an embodiment, the system includes a Card-to-Branch, Branch-to-Card and Branch-to-account Funds Transfer module, whereby the Anywhere Money accounts are held in a central branch of the bank, whereas the customers may have accounts in a branch of the bank. The system allows transfer of funds between a card account and other non-card accounts. The system further includes Card-to-Branch transfer module that can used in following scenarios: A customer wants to transfer funds from his/her AWM account to a local account and the receipt printed from this transaction is equivalent to a cheque issued in the name of “Yourself” as typically used in banking systems when a customer needs to pay to the bank, like request for demand draft, open a new Fixed Deposit account, credit amount into a loan account. The system further includes a Branch-to-Card transfer module that can be used in following scenarios: A customer wants to transfer funds from his/her local account to the AWM account. A person, who may or may not be a customer of the bank and may or may not have an AWM account wants to deposit money into a third person's AWM account in same or any other branch of the bank.

According to a first aspect of the present disclosure, a system for multi-level transaction authorization in a banking support unit includes: a data center with a cluster further comprising: (i) a host for processing transactions, (ii) a security module authenticating and generating a customer personal identification number (PIN), authentication means for authenticating a point-of-sales (POS) terminal, and encryption means for encrypting all information and POS transactions and (iii) an interface for an electronic financial switch for reading a request from said switch, deciphering said request, forwarding requests to said host for processing and sending processed information to said switch and data storage means for data storage; and a maker-checker unit further comprising: a token number generator for conducting sensitive transactions on said POS by unique tokens validated for adaptability with said cluster; and an authorization cards array to configured to effectuate multi-level authorization of primary and subsidiary transactions while selectively linking said primary and subsidiary transactions to said token number generator.

Again, according to the first aspect, said POS terminal further comprises a serial interface for external devices selected from a group consisting of a PIN pad and a transaction slip printer.

Again, according to the first aspect, the authorization cards array comprises: transaction authorization cards to verify financial transactions; branch master card enabling a banking support branch head to authorize cards pertaining to said banking support branch; account operation cards enabling a core banking account holder to conduct various banking transactions through said banking support branch; collection cards enabling credit of funds to a core banking account; and POS maintenance cards enabling modification parameter setting on said POS terminal except for financial transactions.

Still according to the first aspect, the banking support branch is a branch approved by a core banking network, said banking support branch further comprising at least one said POS terminal. Further, the POS terminal is adapted to schedule an execution of a transaction on a future date, and wherein said POS terminal displays a graphical list enabling a banker to manually select said future date.

According to a second aspect of the present disclosure, a method for multi-level transaction authorization is disclosed, said method comprising steps of: linking a plurality of POS terminals to a data center with a cluster and linking an account data storage means to said data; creating banking transaction by generating unique token numbers; exclusively authorizing said banking transaction via said unique token numbers; and making primary and subsidiary banking transactions restrictive through authorization cards and selectively restrictive through said unique token numbers.

According to the second aspect, unique token numbers are enabled for conducting sensitive banking transactions on said POS, said unique token numbers validated for compatibility with said cluster. Still according to the second aspect, the step of linking a plurality of POS terminals comprises step of configuring an electronic financial transaction switch in said data center for, sending and receiving information via said POS terminal, and sending and receiving information via said account data storage means, pertaining to core banking branches.

Again, according to the second aspect, the step of configuring said electronic financial switch further comprises steps of adapting said electronic financial switch to selectively route transactions to and from said core banking branches based on a bank identification number; and further adapting said electronic financial switch to fetch and store information of all such transactions in an operations center.

Still, according to the second aspect, the step of making primary and subsidiary transactions restrictive comprises steps of: enabling a banking branch head to authorize all cards pertaining to a banking branch; securely endorsing said unique token number by swiping authorizer cards while conductive sensitive banking transactions; enabling credit of funds to an account and debit of funds from an account; enabling modification parameter setting on said PUS terminal excluding financial transactions; transferring funds from a first banking account to a second banking account after validating manual communication of said unique token number from transferor to transferee, said transferring funds selectively scheduled for credit and debit operations; imposing POS terminal specific transaction limits; linking core banking transactional limits to said POS terminal specific transaction limits; and issuing cheque books and clearing cheques responsive to said unique token number.

Further, the step of transferring funds comprises a step of enabling a banker exercise an option selected from carrying out a transaction immediately, and on a future date, and wherein an amount pertaining to said transaction is blocked in transferor's account and transferee accepts said amount on receiving said unique token number.

Still according to the second aspect, the method includes configuring collection cards for enabling equated monthly installment (EMI) payment through said POS terminals. The method still includes a step of validating a new banking card via a one-time PIN in a banking support branch.

In an embodiment, the system can include a Network Access Controller (NAC) that is a modem bank of synchronous data link control (SDLC) moderns that provides dialup connectivity to the POS terminals. The modem of the NAC can support speeds from 1200 baud to 9600 baud. The NAC accepts the call from the POS terminal strips the SDLC header and forwards the data to the EFT switch. One modem port of the NAC can support 40 POS terminals (1:40 is an international standard) in an embodiment of the disclosure. The NAC has a management interface for monitoring and management of the moderns. It has an Ethernet interface which connects to the LAN and is used to interact with the EFT switch. The Host Security Module (HSM) The Host security module authenticates and generates a customer PIN. It uses single DES for encryption and it can generate session keys for encryption of a POS transaction. A new key can be generated for every session. The HSM also authenticates a POS terminal during a logon message. The current HSM is a serial HSM which can authenticate 12 transactions/second in an embodiment. The electronic financial transaction (EFT) switch is the heart of the apparatus. The switch routes transactions from various delivery channels to the correct Bank host based on a bank identification number (BIN). It maintains information on Customer Cards, Delivery channels, whereby host systems and can interface with other EFT switches for Inter Institution transactions. It supports the IS08583, NCR NDC and Diebold D9 12 protocols. It supports delivery channels like POS and ATM's. Further, entire customer card management including banking card generation, hot carding, card expiry is done by the EFT switch. The EFT switch accepts a transaction from the delivery channel validates the Customer card number, expiry date verifies if the card is active or hot and then forwards the transaction to the Bank host, else it will return an error message to the delivery channel. It maintains a log of every transaction that is sent by a delivery channel.

Further, the EFT switch assures transaction completion. It will either give a success or a failure for every transaction that enters the switch. The service interface in the data center is part of the cluster an is in accordance with a preferred embodiment of this disclosure a IS08583 Service The IS08583 service is an interface between the EFT switch and the Host. It works as an IS08583 translation service between the EFT switch and the Host. It reads a request from the EFT switch in IS08583 format deciphers it and forwards the transaction to the Host in the cluster. The host processes the transaction and sends a response to the IS08583 service. The IS08583 service reads the response sent by the Host and responds to the EFT switch in IS08583 format, The IS08583 service in accordance with one embodiment is a Java application and it connects to the host over a JDBC (java database connectivity) based connection. The IS08583 service also does logging of every transaction sent by the EFT switch to the host. It also maintains a queue in case the host is busy.

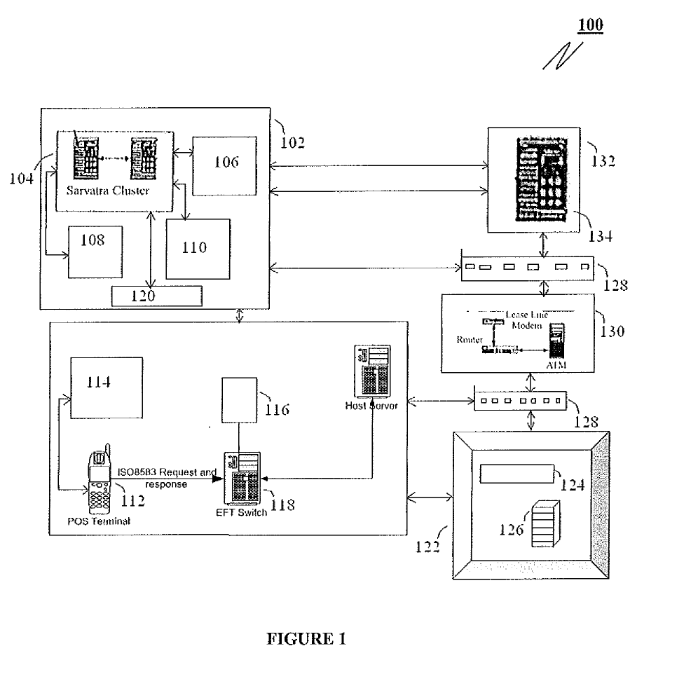

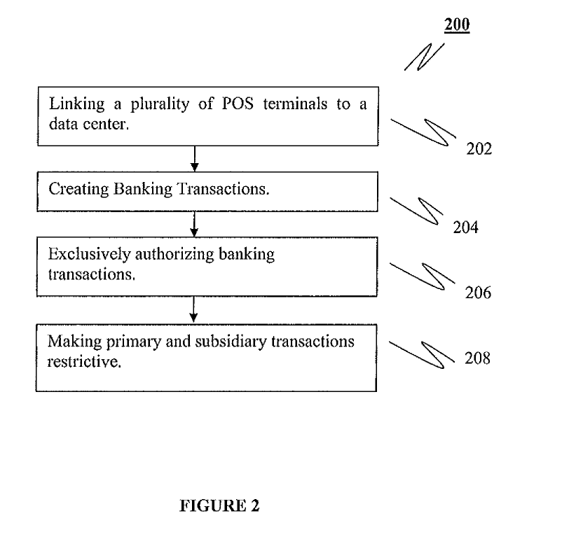

Aspects of the disclosure will become apparent by consideration of the accompanying drawings and their descriptions stated below, which is merely illustrative of a preferred embodiment of the disclosure and does not limit in any way the nature and scope of the disclosure in which, FIG. 1 is a schematic of a system for configuring multi-level authorization in a banking support unit; and FIG. 2 is a flowchart depicting a method of multi-level authorization in a banking support unit.

Referring to the accompanying drawing, FIG. 1 shows a schematic 100 of the system configured for multi-level transaction authentication in a banking support unit linked to a core banking network, The schematic 100 includes a data center 102 with a cluster 104 further comprising a host 106 for processing transactions, a security module 108 authenticating and generating a customer personal identification number (PIN), authentication means 110 for authenticating a point-of-sales (POS) terminal 112, and encryption means 114 for encrypting all information and POS transactions, and an interface 116 for an electronic financial switch 118 for reading a request from said switch, deciphering said request, forwarding requests to said host 106 for processing and sending processed information to said switch and data storage means 120 for data storage. The schematic includes a maker-checker unit 122 further comprising: a token number generator 124 for conducting sensitive transactions on said POS by unique tokens validated for adaptability with said cluster; and an authorization cards array 126 to configured to effectuate multi-level authorization of primary and subsidiary transactions while selectively linking said primary and subsidiary transactions to said token number generator 124.

Further, a network unit 128 connects units 102 through 126 to a commercial/cooperative/institutional/nationalized banking branch 130 for integrating primary and subsidiary banking transactions with the system. In an embodiment, the network unit 128 can include a Wireless/WAN/LAN network powered for connectivity by an array of router devices. The data center 102 is coupled to an operations center 132 for maintaining banking transaction operations of the system. The operations center 132 can include an offsite back up server 134.

In an embodiment, the POS terminals 112 have a serial interface for external devices such as a printer, PIN Pad and the like. In addition, the POS terminals 112 have an Ethernet interface for connecting the POS to a local area network and an interface for connecting the POS to an Internet Services Provider (ISP). In accordance with a preferred embodiment of this disclosure, the data center includes a network access controller comprising a bank of modems for dialup connectivity with the POS terminals and adapted to accept information from the POS terminals and forward to the electronic financial switch. Further, the POS terminal envisaged in accordance with this disclosure will be interfaced with the customer's branch via Network Interfaces PSTN Dialup, GSM Ethernet, and internetwork. In accordance with an embodiment of the disclosure, the branches of the core banking unit can be permanently connected to a data center using any of the aforesaid network interfaces. The POS sends messages to the EFT (electronic financial transaction) switch in IS08583 format. The IS08583 format is the International Organization for Standardization standard for systems that exchange electronic transactions made by cardholders using payment cards. The various transactions possible from the POS include: Balance Enquiry, Cash Withdrawal, Cash Deposit, Funds Transfer Debit Sale, Pin Change, and Reversals Settlement,

Referring to the accompanying drawing, FIG. 2 shows a flow chart 200 of a method for multi-level transaction authorization and authentication in a banking support unit linked to a core banking network. A first step 202 includes linking a plurality of POS terminals to a data center and account data storage means to said data center via a network such as public switched telephone network (PSTN) dialup, Internet and Ethernet for accessing accounts of any account holder in any branch of a bank. A second step 204 includes creating banking transactions by generating unique token numbers. A third step 206 includes exclusively authorizing said banking transaction via said unique token numbers. A fourth step 208 includes making primary and subsidiary banking transactions restrictive through authorization cards and making transactions selectively restrictive through said unique token numbers.

### TECHNICAL ADVANTAGES AND ECONOMIC SIGNIFICANCE

The technical advancements of the present disclosure include providing a multi-level transaction authorization in a banking support unit that is linked to a core banking network,

The system envisaged by the present disclosure enables any-where-money transactions using POS. The system achieves anywhere banking using simple devices like EFT Point of Sale (PDS) terminals that interact with a core banking system using basic communication medium like dial-up over wired or wireless telephone networks. Advanced cards are configured in addition to regular account operation cards including: transaction authorization cards with photograph, issued to employees of the bank who will be allowed to authorize various transactions in the system. Branch key cards are in the ownership of the person in charge (typically the branch manager) of the branch of the bank where the POS terminal is installed, The key card is linked to a reconciliation account for that branch. Account operation cards are cards with photograph of the account holder and can be used to carry out various banking transactions on the account. Collection cards are non-photo cards which only allow funds to be credited to the account. Even balance inquiry is not possible with these cards. POS maintenance cards are cards only allow viewing/modification of certain parameter setting on the POS terminal. No financial transaction is possible with these cards. Such cards are typically given to service engineers who maintain the POS terminals.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A computer implemented multi-level transaction authorization system, said system comprising:
a data center with a cluster further comprising: (i) a host for processing transactions, (ii) a security module authenticating and generating a customer personal identification number (PIN), authentication means for authenticating a point-of-sales (POS) terminal, and (iii) an interface for an electronic financial switch for reading a request from said switch, deciphering said request, forwarding requests to said host for processing and sending processed information to said switch and data storage means for data storage; and
a maker-checker unit further comprising: a token number generator for conducting sensitive transactions on said POS by unique tokens validated for adaptability with said cluster; and an authorization cards array to configured to effectuate multi-level authorization of primary and subsidiary transactions while selectively linking said primary and subsidiary transactions to said token number generator.

2. A system as claimed in claim 1, wherein said POS terminal further comprises a serial interface for external devices selected from a group consisting of a PIN pad and a transaction slip printer.

3. A system as claimed in claim 1, wherein said authorization cards array comprises:
transaction authorization cards to initiate certain transactions and to verify transactions by seconding a unique token number generated by said token number generator;
branch master card enabling a banking support branch head to authorize cards pertaining to said banking support branch;
account operation cards (similar to ATM/debit cards) enabling a core banking account holder to conduct various banking transactions through said banking support branch;
collection cards enabling credit of funds to a core banking account; and
POS maintenance cards enabling modification parameter setting on said PUS terminal except for financial transactions.

4. A system as claimed in claim 1, wherein said banking support branch is a branch approved by a core banking network, said banking support branch further comprising at least one said PUS terminal.

5. A system as claimed in claim 1, wherein said POS terminal is further adapted to schedule an execution of a transaction on a future date, and wherein said POS terminal displays a graphical list enabling a banker to manually select said future date.

6. A computer implemented method for multi-level transaction authorization, said method comprising:
linking a plurality of POS terminals to a data center with a cluster and linking an account data storage means to said data center;
creating banking transaction thereby generating unique token number for each transaction;
exclusively authorizing said banking transaction via said unique token numbers; and
making primary and subsidiary banking transactions restrictive through authorization cards and selectively restrictive through said unique token numbers.

7. A method as claimed in claim 6, wherein said unique token numbers are enabled for conducting sensitive banking transactions on said POS, said unique token numbers validated for compatibility with said cluster.

8. A method as claimed in claim 6, wherein the step of linking a plurality of POS terminals comprises a step of configuring an electronic financial transaction switch in said data center for, sending and receiving information via said POS terminal, and sending and receiving information via said account data storage means, pertaining to core banking branches.

9. A method as claimed in claim 8, wherein the step of configuring said electronic financial switch further comprises steps of: adapting said electronic financial switch to selectively route transactions to and from said core banking branches based on a bank identification number; and further adapting said electronic financial switch to fetch and store information of all such transactions in an operations center.

10. A method as claimed in claim 6, wherein the step of making primary and subsidiary transactions restrictive comprises steps of:
enabling an authorized person to authorize all cards pertaining to a banking branch;
securely endorsing said unique token number by swiping authorizer cards while conductive sensitive banking transactions;
enabling credit of funds to an account and debit of funds from an account;
enabling modification parameter setting on said POS terminal excluding financial transactions;
transferring funds from a first banking account to a second banking account after validating manual communication of said unique token number from transferor to transferee, said transferring funds selectively scheduled for credit and debit operations;
imposing POS terminal specific transaction limits;
linking core banking transactional limits to said POS terminal specific transaction limits; and
issuing cheque books and clearing cheques responsive to said unique token number.

11. A method as claimed in claim 10, wherein the step of transferring funds comprises a step of enabling a banker exercise an option selected from carrying out a transaction immediately, and on a future date, and wherein an amount pertaining to said transaction is blocked in transferor's account and transferee accepts said amount on receiving said unique token number.

12. A method as claimed in claim 6, further comprising a step of activating a new banking card using a authorization card and changing the standard PIN of the new card in a banking support branch.

13. A method as claimed in claim 6, further comprising a step of rejecting all financial transactions from a card unless its PIN is set to anything other than the standard PIN.
